(19) United States
(12) Patent Application Publication
(10) Pub. No.: US 2010/0251956 A1
(43) Pub. Date: Oct. 7, 2010

(54) Manual inclinometer systems and methods for preventing motor vehicle crashes

(76) Inventor: Steven Robert Hilliard, Knoxville, TN (US)

Correspondence Address: Steven Hilliard, 6043 Tennyson Dr., Knoxville, TN, 37909, US

(21) Appl. No.: 12/714,344

(22) Filed: Feb. 26, 2010

Related U.S. Application Data
(60) Provisional application No. 61/208,821, filed on Feb. 27, 2009.

(51) Int. Cl. B60Q 11/00; G01B 1/00

(52) U.S. Cl. 116/35 R

(57) ABSTRACT

The most common “critical reason” (22.3%) for single-vehicle large truck crashes is “too fast for curve/turn” which leads directly to rollovers and skids. Manual Inclinometer System(s) (MIS) can provide an extremely inexpensive and reliable heads-up visual warning to drivers when their vehicle is going too fast for any (dry) curve or turn, and thereby prompt them to slow down before it is too late. Approximately 15,000 large truck rollovers occur in the U.S. each year, and as many as 4,000 of these crashes may be preventable using MIS. When the relative lateral acceleration of any “too fast for curve/turn” condition exceeds a preset threshold, then the MIS unit can also (optionally) latch-up in order to provide a warning to fleet safety managers and/or law enforcement that a driver is at high risk for having a preventable rollover crash. Drivers posing a high risk for preventable rollover crashes may also pose a high risk for other types of crashes, so identifying these drivers in advance may help to prevent these other types of crashes as well. Heads-up MIS have the potential to help prevent rollover crashes for vehicles with dynamic rollover thresholds below their skidding thresholds, and latching MIS have the potential to help identify high-risk driving behavior for any vehicle type.

### CROSS-REFERENCE TO RELATED APPLICATIONS

This application claims the benefit of U.S. Provisional Application No. 61/208,821 filed Feb. 27, 2009.

### BACKGROUND OF THE INVENTION

When a large truck is involved in a serious single-vehicle crash, the most likely (22.3%) critical reason for that crash is “too fast for curve/turn” which leads to either a rollover or skid.

There were 141,200 fatal or serious injury crashes in the U.S. involving large trucks during one 33-month period while data was being collected for The Large Truck Crash Causation Study (LTCCS) [1]. The goal of the LTCCS is to identify effective crash countermeasures. In this sense, the present invention is such an effective crash countermeasure.

Of the 10,138 people in the U.S. who were killed in rollover crashes (including automobiles) in 2001, 83% were killed in single-vehicle rollover crashes.—National Highway Traffic Safety Administration (NHTSA).

There are also many passenger car and motorcycle crashes each year due to the “too fast for curve” critical reason, so Manual Inclinometer System(s) (MIS) could easily turn out to be cost effective for deployment in every vehicle on the road.

About 4.9% (over 100,000/yr. in the U.S.) of serious passenger car crashes are due to “too fast for curve” critical reason.

“In order to significantly reduce the high number of highway traffic fatalities and injuries, more needs to be done for primary prevention (i.e., finding ways to prevent crashes by understanding the pre-crash circumstances.)” [2]

“Compared with a passenger car occupant, a motorcycle rider is 26 times more likely to die in a crash, based on vehicle miles traveled.”—Traffic Safety Facts, 2004; http://www-nrd.nhtsa.dot.gov/Pubs/809734.PDF

“Approximately one-fourth of these motorcycle accidents were single vehicle accidents involving the motorcycle colliding with the roadway or some fixed object in the environment . . . . In single vehicle accidents, motorcycle rider error was present as the accident precipitating factor in about two-thirds of the cases, with the typical error being a slideout and fall due to overbraking or running wide on a curve due to excess speed or under-cornering . . . . Weather is not a factor in 98% of motorcycle accidents.” [5]

Preventable crashes due to the “too fast for curve/turn” critical reason may be preceded by near-miss incidents for which there is little or no physical evidence left behind to let the driver, the vehicle's owner, and/or law enforcement officials know that a serious accident almost happened.

### BRIEF SUMMARY OF THE INVENTION

According to the present invention, methods and apparatuses are provided to detect (pre-rollover) when an excess relative lateral acceleration is acting on a land vehicle (in the banking and rotating reference frame of the vehicle), such as may occur during a “too fast for curve/turn” incident for example; to warn the driver in real time of imminent danger; and to optionally leave a durable indication of the incident to inform the owner of the vehicle, the insurance underwriter of the vehicle, and/or law enforcement officials. Optional tamper-resistant/evident means may be provided to prevent drivers from easily concealing evidence of a serious incident from vehicle owners and/or law enforcement authorities. It is expected that incidents of excess relative lateral acceleration acting on a motor vehicle which would be necessarily reportable to employers and/or law enforcement authorities would have a relatively high threshold, and that detections from less-serious incidents (which may be of interest only to the driver) would have a somewhat lower threshold to give drivers a comfortable margin for modifying their own driving behavior before it is necessarily brought to the attention of vehicle owners, insurance underwriters, or law enforcement authorities.

The immediate problem that the present invention addresses is the propensity of large trucks to roll over in curves and turns without warning (e.g., large trucks typically roll over in curves and turns before skidding).

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 illustrates a Gas-Bubble Inclinometer-Manual Inclinometer System (GBI-MIS) with a dead-band of ±0.20(g), and a Peak-to-Peak (P-P) relative lateral acceleration indication of ±0.30(g).

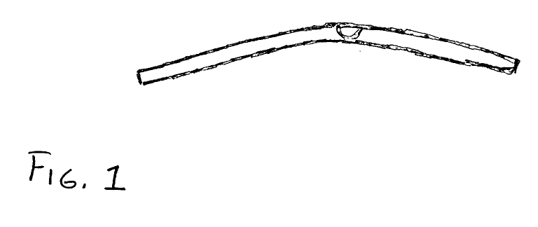

### DETAILED DESCRIPTION OF THE INVENTION

For vehicles with a high-enough dynamic rollover threshold, passenger cars for example, the vehicle will typically skid before rolling over. However, because the dynamic rollover threshold for large trucks (typically between 0.35-0.40 g [6]) is below their skidding threshold for dry pavement (typically ˜0.8 g), they are prone to rolling over in curves and turns without warning.

Advisory speeds are posted for many sharp curves. These speeds are determined based on the radius of the curve (a_{y}=v²r⁻¹ for an un-banked curve) so that the relative lateral acceleration acting on vehicles (in the banking and rotating reference frames of the vehicles), particularly for large trucks, rounding the curve does not exceed approximately ±0.2 g.

However, this does not always prevent large truck rollovers due to the “too fast for curve/turn” critical reason because: 1) advisory speeds are not posted for every curve and turn, “Only about 7 percent of cargo tank rollovers occur on entrance or exit ramps” [3]; 2) drivers may think that the posted advisory speed is too conservative for their taste; 3) drivers may not take notice of the advisory sign even when it is in plain view; 4) drivers may not be aware of their own speed as they traverse a curve or turn . . . the steering wheel often obscures the speedometer gauge in a tight turn, or they may be distracted, for example; 5) vehicle speed may subtly increase as a curve winds downhill; 6) some advisory speed signs are obscured from view (e.g., foliage, snow, vehicles parked in the breakdown lane, etc.) or missing; 7) some posted advisory speeds are improperly calculated; 8) etc.

Some large truck rollovers occur due to load shifts in curves and turns even when the vehicles are traveling below the posted advisory speed (e.g., at relative lateral accelerations below ±0.2 g). Manual Inclinometer System(s) (MIS) units can be calibrated for these special loads or generalized for use with any load, and at least some large truck rollovers due to load shifts could be prevented in this way.

Our innovative approach to this problem is to provide the driver with an extremely inexpensive heads-up MIS display that directly measures the lateral acceleration acting on the vehicle relative to (in the reference frame of the vehicle) vertical acceleration, and visually indicates when this relative lateral acceleration exceeds ±0.2 g. For maximum visibility, the MIS unit can be mounted directly on the windshield of the truck (e.g., as a “heads-up” display) so that the driver can comfortably glance at the instrument while traversing any curve or turn, or the MIS unit can be mounted in plain view on either the dashboard or instrument panel of the vehicle.

The central idea behind Gas-Bubble Inclinometers—Manual Inclinometer Systems (GBI-MIS) is to provide the driver with an easily accessible indication of lateral acceleration relative to the roll stability limits of the vehicle. A panel-mount GBI-MIS could also be placed in the top curve of this truck's instrument panel, and artificial backlighting would be particularly easy to provide if installed at the time the vehicle is manufactured.

Either way, this allows the driver to objectively determine when the relative lateral acceleration acting on their vehicle exceeds ±0.2 g in any curve or turn without reference to posted advisory speeds. Drivers may ignore the heads-up MIS until they suddenly become aware that they are, or may be, in a “too fast for curve/turn” situation. Then they can quickly glance at the heads-up MIS to help them objectively determine how fast is too fast for the curve or turn. Without a posted advisory speed (read and understood by the driver before entering the curve) or a heads-up MIS to refer to, a driver's sense of how fast is too fast for a curve/turn is substantially subjective.

There are nine basic GBI-MIS parameters that may be specified by a motor carrier: 1) the dead-band, 2) the warning band, 3) the frequency response, 4) the size of the device, 5) color-coding or other indicia, if any; and 6) the latch-up threshold, if any; 7) where the device is mounted on the vehicle; 8) backlighting, if any; and 9) tamper-evident adhesive means, if any. Our recommended dead-band which corresponds to standard curve advisory speeds is ±0.2 g, but a narrower dead-band may be needed for loads with high centers of gravity or that are otherwise highly prone to shifting in curves or turns. The dynamic rollover threshold for large trucks is typically between 0.35-0.40 g, so the GBI-MIS warning band for large trucks should typically be set somewhere below ±0.35 g. Latching GBI-MIS will latch-up when the relative lateral acceleration acting on the vehicle exceeds the warning band limit.

The frequency response characteristics of a MIS determine how fast its output indication will respond to changes in the relative lateral acceleration of the vehicle. It is desirable for latching MIS to be relatively insensitive to transient lateral accelerations lasting less than about one second in duration because large trucks often encounter potholes/craters in poorly maintained parking lots and docking areas that can momentarily exceed the dynamic rollover threshold of the vehicle. However, large trucks do not usually roll over when they encounter these large transient rolling forces because they are only brief encounters. Manually shifted trucks can also encounter transient rolling forces in excess of the dynamic rollover threshold, even on smooth pavement, due to “lugging” of the engine. This is less likely to occur with auto-shift transmissions, but it still happens occasionally.

On the other hand, it is useful for heads-up MIS to have a relatively higher frequency response in order to provide a prompt visual warning to drivers as “too fast for curve/turn” situations arise.

For any given cross-sectional area of a fluid-filled GBI-MIS tube, the frequency response of the GBI-MIS is roughly inverse-proportional to the size of the gas bubble indicator. Gas bubbles with a smaller cross-section than the fluid-filled tube are able to change positions within the tube more quickly than larger bubbles. Heads-up MIS that also latch can be designed with fluid-filled tubes of varying cross-section in order to provide a relatively fast frequency response at the low-end of the warning band, and a relatively slow frequency response at the high-end of the warning band immediately ahead of the latch-up threshold.

All of the GBI-MIS prototypes that we have built and tested so far have been similar to common bubble levels (or “spirit levels”) in construction except that the level angle of our fluid-filled tubes vary along the length of each MIS. The “level angle” of a GBI-MIS for any given relative lateral acceleration, a_{y}a_{z} in the reference frame of the vehicle, is equal to: arctan(a_{y}a_{z}) in a plane normal to the longitudinal axis of the vehicle's reference frame. We could mount a fiduciary GBI-MIS on the windshield, dashboard, or instrument panel of any given vehicle make/model, and record HD video of the GBI-MIS actual response to various known relative lateral accelerations as measured by an electronic 3-axis accelerometer. Then we could inscribe a calibrated scale, or color-coded scale, for a GBI-MIS that is customized for that particular make/model of vehicle.

For example, the level angles for a dead-band of ±0.2 g are between ±11.3°, and the level angles for a warning band of ±0.30 g P-P (Peak-to-Peak) are between ±16.7°. We constructed a rigid pattern for our first prototype GBI-MIS from a laser-cut stainless steel sheet using the services of eMachineShop.com.

This particular pattern may be used to construct GBI-MIS with warning bands of ±0.30 g P-P, and with or without a dead-band of ±0.2 g. The ±0.2 g relative lateral acceleration band is indicated (in green) in the drawing for both GBI-MIS patterns. The dead-band can be implemented by removing the corresponding range of level angles from the arc, by obscuring the driver's view of the bubble along the corresponding range of level angles, by color coding this range of level angles (green color code for example), or by implementing separate left-turn and right-turn MIS units along the appropriate arc segments.

We have tested prototype GBI-MIS units in our own personal vehicles so that we could safely drive them though their full Peak-to-Peak ranges of relative lateral acceleration. A bobtail large truck power unit could also be used to safely measure the actual response of truck-mounted GBI-MIS to a wide range of relative lateral accelerations.

It is easy to make and test heads-up GBI-MIS by hand. Simply fill a length of clear plastic tubing with denatured ethanol, and plug both ends leaving a small gas bubble to serve as an indicator. Then mount the tube on the instrument panel, dashboard, or windshield of the vehicle on an inverted arc. The relationship between relative lateral acceleration and level angle along the length of the arc may be calculated in advance if the curvature of the arc is known, or it can be measured by driving the vehicle along a curve and associating measured relative lateral accelerations with the observed displacements of the gas bubble. The tube may then be marked to show the dead-band, warning band, and red-band (if any) for example. The tube segments corresponding to these different bands may be color-coded to help drivers readily interpret the level of danger associated with each band. The boundary between the warning band and the red band should correspond to the g-level at which a latching GBI-MIS would latch-up if mounted on this vehicle. A GBI-MIS can be made to latch-up when a pre-determined relative lateral acceleration is experienced simply by upturning the end of the liquid-filled tube after the appropriate level angle to form a “trap” for the bubble.

In large-scale production we would expect to have our GBI-MIS formed by injection molding the units from clear PVC, polystyrene, or polycarbonate plastic.

We filled our prototype GBI-MIS units with denatured ethanol because of the low melting point: −114.1° C. In practical application, the use of denatured ethanol will ensure that these devices will not freeze-up during normal use even in harsh environments.

We have found gas-bubbles to be a convenient way for implementing our prototype manual inclinometers, but they could also be implemented using low-density spheres as the indicators within inverted fluid-filled tubes.

Other mechanical means, such as geared pendulums for example, could alternately be used to implement MIS to accomplish our goal of reliably reducing “too fast for curve/turn” crashes at a low cost. Such alternate means may be preferred by some Commercial Motor Vehicle (CMV) manufacturers desiring to integrate MIS into their pre-existing instrument panel designs. The key elements of MIS for crash reduction are: low-cost, dead-band, warning-band, heads-up display, optional latch-up, and low-pass frequency response for latching MIS.

Latching GBI-MIS differ only slightly in construction from heads-up GBI-MIS in that the fluid-filled tubes are up-turned on the ends so that when a bubble exceeds the limit of a warning band at least some of the bubble will become trapped in an upturned section of the tube. By trapping some of the bubble, but not all of it, the inclinometer can continue to function while simultaneously indicating one or more latched states. Multiple latched states can be indicted by trapping a suitably small portion of the bubble for each state indication.

Latching GBI-MIS may be mounted to the vehicle using a tamper-evident adhesive tape so that drivers can't easily hide a latch-up event from their safety managers and/or law enforcement.

### Potential Payoff for Practice

The most straight forward potential benefit from implementing MIS in practice is a reduction of up to 22.3% (˜4,000/yr. in U.S.) of single-vehicle large truck crashes due to the “too fast for curve/turn” critical reason. Truck drivers who do not exceed the dynamic rollover thresholds of their vehicles will not become involved in a “too fast for curve/turn” single-vehicle crash. So, to the extent that we are able to prevent truck drivers from exceeding this critical threshold, then we can prevent their vehicles from crashing due to the “too fast for curve/turn” critical reason. Over 100,000 passenger car crashes occur each year in the U.S. due to the “too fast for curve” critical reason as well, so heads-up MIS may turn out to be cost effective regardless of vehicle type.

Heads-up MIS will help drivers learn to recognize when they are in or near a “too fast for curve/turn” situation, and how to take prompt action (by slowing down) to avoid a potential rollover or skid. Latching MIS will help to identify drivers who are at high risk for crashes due to the “too fast for curve/turn” critical reason, but to actually prevent excess crashes caused by these drivers the participating motor carriers would have to take effective action when a driver latches their MIS (e.g., when they have driven a vehicle “too fast for curve/turn”). We do not know at this time what the most effective action would be. Termination of employment would simply shift these drivers to another motor carrier, so that wouldn't seem to be an effective action to reduce crashes overall. Some role for law enforcement may be required to take full advantage of latching MIS.

Of the 10,138 people in the U.S. who were killed in rollover crashes (including automobiles) in 2001, 83% were killed in single-vehicle rollover crashes.—National Highway Traffic Safety Administration (NHTSA).

Other types of crashes, including multiple vehicle large-truck crashes and passenger car crashes, may also be prevented through the use of latching MIS to help identify drivers who are at generally high risk for being involved in preventable crashes of all kinds.

Drivers who are identified by MIS latch-ups as being at high risk for single-vehicle large truck crashes due to the “too fast for curve/turn” (22.3%) critical reason may also be at high risk for single-vehicle crashes due to these other critical reasons [1]:

| | |
|---|---|
| “Sleep, that is, actually asleep” | (12.8%) |
| “Cargo shifted” | (6.6%) |
| “Too fast for conditions to be able to respond . . . ” | (6.4%) |
| “Inattention (i.e., daydreaming)” | (5.9%) |
| “Overcompensation” | (4.2%) |
| “Poor directional control e.g., failing to control vehicle . . . ” | (4.0%) |
| “Inadequate surveillance (e.g., failed to look, looked but . . . | (3.6%) |
| “Internal distraction | (3.4%) |
| “Aggressive driving behavior | (2.1%) |
| “Unknown critical non-performance | (1.3%) |
| “Other decision error | (1.3%) |
| “External distraction | (0.9%) |
| “Illegal maneuver | (0.4%) |
| “Following too closely to respond to unexpected actions | (0.4%) |
| “Other critical non-performance | (0.4%) |
| “Misjudgment of gap or other's speed | (0.2%) |

For example, drivers who exhibit “aggressive driving behavior” might tend to round curves and turns too fast as well. MIS can identify such drivers through their “too fast for curve/turn” behavior.

Heads-up MIS will help drivers learn to recognize a dangerous “too fast for curve/turn” critical condition, and then to take prompt effective action (e.g., by slowing down) to avoid a rollover or skid.

The extremely low cost and high reliability of MIS makes for a potentially favorable benefit/cost ratio even if only a small number of large truck crashes due to the “too fast for curve/turn” critical reason are actually either prevented or reduced in severity with their use.

Roll Stability Control (RCS) systems have been installed in a relatively small number of CMVs. [7] There is no clear evidence that RCS systems are cost effective, and they may become even less cost effective (and the same goes for systems such as LG Alert) if the incidence and severity of crashes due to the “too fast for curve/turn” critical reason can be significantly reduced through the use of MIS alone.

Road departure crashes account for 15,000 fatalities annually in the U.S., [108] and MIS might be useful for preventing some fraction of these road departure crashes. Successful prevention of a significant fraction of large truck crashes using MIS should lead to follow-on testing with fire trucks, police cars, pickup trucks & SUVs, school busses, rental car fleets, teen drivers, etc. . . .

Many passenger car crashes (over 100,000/yr.) also occur each year in the U.S. due to the “too fast for curve” critical reason. [2] Given the extremely low cost and high reliability of MIS, this simple technology could turn out to be cost-effective for passenger car crash prevention as well.

Heads-up MIS provide(s) many of the same benefits to vehicle operators as claimed for the LG Alert Lateral Acceleration Indicators [14], [19], [11], [12], [13], [15], [17], [20], but with greater reliability and at a much lower cost (LG Alert costs ˜200× more than MIS, and is inherently less reliable). Latching MIS actually exceeds the capabilities of the LG Alert Lateral Acceleration Indicators in some ways. The much lower cost and increased reliability of MIS makes them far more practical and cost effective to deploy on a large scale.

There are many passenger car (˜100,000/yr. in the U.S. alone [2]) and motorcycle crashes due to the “too fast for curve” critical reason, so MIS could easily turn out to be cost effective for deployment in every vehicle on the road.

“Compared with a passenger car occupant, a motorcycle rider is 26 times more likely to die in a crash, based on vehicle miles traveled.” —Traffic Safety Facts, 2004; http://www-nrd.nhtsa.dot.gov/Pubs/809734.PDF

“Approximately one-fourth of these motorcycle accidents were single vehicle accidents involving the motorcycle colliding with the roadway or some fixed object in the environment . . . . In single vehicle accidents, motorcycle rider error was present as the accident precipitating factor in about two-thirds of the cases, with the typical error being a slideout and fall due to overbraking or running wide on a curve due to excess speed or under-cornering . . . . Weather is not a factor in 98% of motorcycle accidents.” [5]

It would also be possible to integrate electronic and/or software (GPS) accelerometers with PrePass transponders, Qualcomm, commercial GPS navigation systems, and/or CMV engine computers. Once the benefits of MIS have been quantified then these higher-cost alternatives can be considered as technically viable substitutes.

We chose Gas-Bubble Inclinometers (GBI) as our illustrative embodiment of MIS because they are simple, effective, extremely low-cost, they do not depend on power supplies, the do not require any software, they are easy to install, and because their indications are reliable and intuitively easy for drivers to interpret.

Electronic and software-based (e.g., GPS navigation systems) accelerometers have some potential advantages in that they can provide audible (preferably annunciated) and visible alerts, record multiple high-g events, and they can be integrated with devices such as PrePass transponders and/or Qualcomm to provide automated indications of unsafe vehicle movements to motor carriers and/or law enforcement:

Some large truck rollovers occur due to load shifts even when the vehicles are traveling below posted advisory speed (e.g., at lateral accelerations below ±0.2 g). Manual Inclinometer Systems (MIS) with g-unit indicia can be interpreted in light of varying loads, and rollovers due to load shifts may be prevented in this way. Color coded indicia may serve well in most cases where ±0.2 g is a safe range of lateral accelerations for the vehicle.

Our innovative approach to this problem is to provide the driver with a heads-up MIS display that directly measures the lateral acceleration acting on the vehicle, and visually indicates, for example, when this acceleration exceeds ±0.2 g. For maximum visibility, the MIS can be mounted directly on the windshield of the truck (e.g., as a “heads-up” display) so that the driver can easily refer the instrument while traversing any turn or curve, or it can be mounted in plain view on the dashboard or instrument panel of the vehicle. Either way, this allows the driver to objectively determine when the lateral acceleration on their vehicle exceeds ±0.2 g in any curve or turn without reference to posted advisory speeds. This range of lateral accelerations is used as an illustrative embodiment, but other ranges can be selected without departing from the spirit and scope of the present invention.

Latching MIS differ in construction from heads-up MIS in that the fluid-filled tubes are up-turned on the ends so that when the bubble reaches the limit of the warning band it will become trapped in the upturned end of the MIS. Latching MIS may also be mounted to the vehicle using a tamper-evident adhesive tape so that drivers can't hide a latchup event from their safety managers.

It is a first object of the present invention to detect an abnormal acceleration of a vehicle using a manual inclinometer, and then to warn the driver of the vehicle by an audible, visible, and/or haptic means.

It is a second object of the present invention to detect an abnormal acceleration of a vehicle using a manual inclinometer, and then to leave a physical indication of the event.

It is a third object of the present invention to detect an abnormal acceleration of a vehicle using an accelerometer, and then to inform the owner of the vehicle (e.g., the driver's employer for example) by transmission of an automated wireless message (e.g., via Qualcomm for example).

It is a fourth object of the present invention to detect an abnormal acceleration of a vehicle using an accelerometer, and then to store a record of the event within an onboard information storage and retrieval system (e.g., a “black box” vehicle data recorder) for later retrieval by the owner of the vehicle and/or law enforcement personnel.

It is a fifth object of the present invention to detect an abnormal acceleration of a vehicle using an accelerometer, and then to store a record of the event within an onboard information storage and retrieval system for later retrieval by law enforcement authorities (e.g., via an augmented PrePass transponder for example).

It is a sixth object of the present invention to provide a reliable low-cost heads-up display of relative lateral accelerations acting on a motor vehicle.

It is a second object of the present invention to provide a reliable low-cost latch-up state indicator of excess relative lateral accelerations that have previously acted on a motor vehicle.

These and other objects of the present invention are useful for preventing large truck rollover crashes due to the “too fast for turn/curve” critical reason, and for identifying unsafe driving behavior regardless of the type of vehicle.

Any motor vehicle with a propensity to roll over in a turn before skidding, large trucks for example, needs to be equipped with a reliable indicator of the relative lateral accelerations acting on the vehicle in order that the driver may avoid rollovers.

In the present invention we provide a low-cost indicator of relative lateral acceleration acting on a motor vehicle. The indicator presents an indication proportional to relative lateral acceleration within a pre-selected range or “band”.

In a tight turn, a driver's attention needs to be primarily focused on lane-keeping and secondarily on maintaining a safe speed. In order to maintain a safe speed, a driver must first determine what is a safe speed for the curve. Many curves are signed with advisory speed limits for large trucks, but many curves are not. Safe speeds for large trucks in right-angle turns and U-turns are particularly low. Once a safe speed for a curve has been determined, then making reference to the speedometer necessarily distracts the driver from their primary focus of lane-keeping; also, it is common for the driver's view of the instrument panel to be obscured in a tight turn due to the way in which steering wheels are designed.

In the present invention, a range, or band, of safe speeds for any turn is bounded by a maximum lateral g-acceleration that is safely sustainable by the vehicle and a safety factor. For example, the dynamic rollover thresholds for large trucks in the U.S. typically fall in a range of 0.35-0.40 g, and AASHTO guidelines for highway design recommend 0.2 g for posted speed advisories for curves. In the illustrative embodiments of the present invention, a dead-band between approximately ±0.2 g is provided wherein the indicator does not respond to relative lateral accelerations acting on the vehicle so that the driver's attention is not distracted by unimportant information. A warning-band between 0.20-0.35 g is provided wherein the indicator responds to warn the driver to slow-down and/or widen the radius of the turn. Beyond 0.35 g the indicator of the illustrative embodiment latches to maintain a record of the event for later reflection by the driver, their employer, and/or law-enforcement authorities. In the illustrative embodiment of the present invention the indicator is mounted on the inside surface of the windshield of the vehicle in order to allow the driver to make reference to the indicator in a tight-turn with minimum distraction from their primary lane-keeping duties, and without being visually obstructed by the steering wheel structure. In another embodiment of the present invention the indicator is mounted on the dashboard of the vehicle. In another embodiment of the present invention the indicator is mounted on the instrument panel of the vehicle. In yet another embodiment of the present invention the indicator is mounted on the outside of the vehicle for convenient reference of the latch-up state by the driver's employer and/or law-enforcement authorities.

A quasi-static model of a rigid, not-suspended vehicle defines the rollover threshold as

$$\frac{{a}_{y , crit}}{g} = \frac{t}{2 {h}_{cg}} + ϕ$$

where t is the vehicle track width, h_{cg} is the vehicle center of gravity height, and φ is the road bank angle. When the bank angle is neglected, this equation is referred to as the static stability factor (SSF).—Gillespie, T. D., Fundamentals of Vehicle Dynamics, Society of Automotive Engineers, ISBN 1-56091-199-9, Warrendale, Pa., 1992.

In the prior-art, near-miss precursor incidents may give little or no warning to the driver, their employer, and/or law enforcement authorities that a serious accident almost occurred.

It is the responsibility of the vehicle owner and driver to determine the appropriate relative lateral acceleration thresholds for any given vehicle, driver, and load. As with posted speed limits on the highway, it is ultimately the responsibility of the driver to drive at a safe speed under all conditions.

Our expected approach to implementation would be for commercial motor vehicle manufacturers to install heads-up MIS on all new CMVs rolling off of their assembly lines, and for motor carriers to install heads-up MIS on all of their pre-existing equipment. Failure to do so could invite thousands of product liability and negligence claims per year. Regulatory requirements would presumably follow once the cost/benefit of heads-up MIS has been well established by multiple independent investigations.

Latching MIS would require ongoing monitoring by motor carriers and or law enforcement in order to be fully effective. These devices could be attached to the outside of CMVs as are other permits and inspection stickers, and then become void when latched. This would require the driver or vehicle owner to replace the latched MIS, or risk fines.

Heads-up MIS may also be useful for other vehicles with dynamic rollover thresholds below their skidding thresholds, so: fire trucks (and other first-responder vehicles), school busses, passenger vans, SUVs, and pickup trucks could all potentially benefit from a reduction of crashes due to the “too fast for curve/turn” critical reason. Latching MIS could be useful in all types of vehicles for the detection of high risk driving behavior.

It is possible that a small group of drivers will be identified that are at high risk for crashes, and then the State Reported Crashes of all kinds that occur will be disproportionately associated with these drivers. Of course, motor carriers could simply terminate the employment of these drivers in order to prevent crashes for their particular fleet, but then these drivers could simply go to work somewhere else and have their crashes there. For that reason, termination of employment is not an appropriate way to deal with such drivers.

To facilitate the visual inspection of latching MIS, these devices should be placed on the outside front driver's side surface of each semi-trailer, and/or on the outside rear driver's side surface of each power unit. Drivers, security guards, and maintenance technicians should make routine inspection records of MIS on semi-trailers and power units as directed by motor carriers.

Drivers who latch the MIS on their power units might not self-report these events in a timely manner, but semi-trailer mounted MIS should latch at the same time as the tractor mounted MIS.

Since semi-trailers are typically shared as a pool between all of the drivers of the same motor carrier, the semi-trailer MIS will help to more rapidly detect some MIS latchups. For example, a first driver latches his tractor and semi-trailer MIS, but fails to report this event in a timely manner. Then a second driver picks-up the semi-trailer with the latched MIS, and reports the event. Now we have a clue to check the latch status of the MIS on the first driver's tractor. Also, if the first driver is involved in a crash before the latch status of his tractor's MIS is detected by security or maintenance staff, the latch status of semi-trailer MIS would allow us to retroactively determine the latch status of this driver's tractor MIS prior to the crash. MIS are likely to latch during a collision, and they are certain to latch during a rollover, so determining the latch status of the MIS immediately prior to the crash would be difficult without semi-trailer mounted latching MIS.

The rear-ends of semi-trailers are subject to slightly higher lateral accelerations in curves and turns due to off-tracking than are the front-ends of the same trailers. For this reason it might be useful to mount latching MIS on the rear-ends of semi-trailers. When this is done, the latching MIS could be mounted on the license tag of the semi-trailer.

Double and triple trailer combinations are more likely to roll over due to the “too fast for curve/turn” critical reason because the rear trailer(s) are exposed to the “crack the whip” effect, so the semi-trailer mounted latching MIS might detect dangerous events that are not detected by the tractor-mounted latching MIS in double/triples combinations.

The teachings of the present invention may also provide safety benefits when used with other classes of vehicle such as: smaller trucks, busses, passenger cars, ATV's, boats, aircraft, etc. without departing from the spirit and scope of the present invention.

The manual inclinometer may be attached to the inside of the vehicle's windshield, or mounted on the dashboard or instrument panel, so that it's indication can be viewed by the public, but so that the device is relatively secure from tampering without the driver's knowledge. When the manual inclinometer system is mounted on the windshield of the vehicle, it is advantageous at night to use the headlight-illuminated roadway immediately ahead of the vehicle as a backlight for viewing the inclinometer under dark conditions.

There are undoubtedly many “too fast for curve/turn” incidents which precede the thousands of fatal and disfiguring accidents which are known to result from this critical reason.

The present invention provides a simple and reliable means for detecting these precursor incidents so that disciplinary action may be taken in, many cases before a driver's behavior leads to a tragic accident.

Many commercial vehicles are routinely monitored by Automated Vehicle Identification (AVI) transponders such as PrePass. It would be useful to integrate a relative lateral accelerometer means with an AVI transponder to allow law enforcement to automatically monitor “too fast for curve/turn” incident counts, severity, etc. for individual commercial vehicles.

GPS navigation systems have detailed internal maps of roadways. In an alternate embodiment of the present invention an advisory speed is calculated for curves and turns along a planned route, and “in-vehicle signage” representing a curve warning is displayed by the GPS navigation system for sharp curves. Audible warnings, and particularly annunciated warnings, are provided when the actual measured speed and acceleration of the vehicle on approach to a curve is projected to result in a relative lateral acceleration through the curve in excess of a pre-determined threshold.

There are products in the prior-art that provide an audible warning (e.g., horn/buzzer) of a “too fast for curve/turn” condition. However, these products pre-suppose that the drivers will take the correct action in response to these warnings.

“The truck driver stated that as he came off the ramp, he looked in the rear view mirror and saw his trailer leaning. He hung onto the steering wheel with both hands and just watched as it went over, as if it were happening in slow motion.”—LTCCS [1] Case ID #800003927 CrashDiscussion

It would be more useful to annunciate a simple instruction, such as “Slow down . . . too fast for curve . . . slow down”.

According to the present invention, drivers are conditioned to take prompt and effective action to reduce their speed or widen their turn radius when a “too fast for curve/turn” condition exists.

The particular details of the design of the manual inclinometer systems and methods may be varied over a wide range without departing from the spirit and scope of the present invention.

### LITERATURE REFERENCES

1. Large Truck Crash Causation Study—Analytical User's Manual, US Department of Transportation—FMCSA & NHTSA, June 2006

TABLE 2
Trucks in Single-Vehicle Crashes by Critical Reason

| Critical Reason | Number | Percentage |
|---|---|---|
| Too fast for curve/turn | 9,000 | 22.3% |
| Sleep, that is, actually asleep | 5,000 | 12.8% |
| Cargo shifted | 3,000 | 6.6% |
| Too fast for conditions to be able to respond . . . | 2,000 | 6.4% |
| Inattention (i.e., daydreaming) | 2,000 | 5.9% |
| Heart attack or other physical impairment of the | 2,000 | 5.9% |
| ability . . . | | |
| Overcompensation | 2,000 | 4.2% |
| Poor directional control e.g., failing to control | 2,000 | 4.0% |
| vehicle . . . | | |
| Critical event not coded to this vehicle | 1,000 | 3.8% |
| Inadequate surveillance (e.g., failed to look, | 1,000 | 3.6% |
| looked but . . . | | |
| Type of driver error unknown | 1,000 | 3.5% |
| Internal distraction | 1,000 | 3.4% |
| Unknown recognition error | 1,000 | 2.8% |
| Aggressive driving behavior | 1,000 | 2.1% |
| Suspension failed | 1,000 | 2.1% |
| Degraded braking capability | 1,000 | 2.0% |
| Unknown critical non-performance | * | 1.3% |
| Other decision error | * | 1.3% |
| Tires/wheels failed | * | 1.0% |
| Road design - other | * | 0.9% |
| External distraction | * | 0.9% |
| Brakes failed | * | 0.8% |
| Slick roads (low friction road surface due to ice . . . | * | 0.6% |
| Illegal maneuver | * | 0.4% |
| Following too closely to respond to unexpected | * | 0.4% |
| actions | | |
| Other critical non-performance | * | 0.4% |
| Wind gust | * | 0.3% |
| Steering failed | * | 0.2% |
| Misjudgment of gap or other's speed | * | 0.2% |
| Unknown reason for critical event | * | 0.1% |
| Road design - roadway geometry (e.g., ramp | 0 | 0.0% |
| curvature) | | |
| Total | 38,000 | 100.0% |

2. National Motor Vehicle Crash Causation Survey—Report to Congress, US Department of Transportation—NHTSA, July 2008.
“About 34 percent of the driver-related critical reasons were decision errors that included too fast for conditions (8.4%), too fast for curve (4.9%), false assumption of others' actions (4.5%), illegal maneuver (3.8%), and misjudgment of gap or others' speed (3.2%). In about 10 percent of the crashes, the critical reason was a performance error, such as overcompensation (4.9%), poor directional control (4.7%), etc.”
“In order to significantly reduce the high number of highway traffic fatalities and injuries, more needs to be done for primary prevention (i.e., finding ways to prevent crashes by understanding the pre-crash circumstances.)”
“Understanding the critical pre-crash events and the reasons underlying the critical pre-crash events is important, as these are essential parameters in the design and evaluation of crash-avoidance technologies.”
3. Cargo Tank Roll Stability Study—Final Report, Battelle for USDOT—FMCSA, 2007.

“Only about 7 percent of cargo tank rollovers occur on entrance or exit ramps. A driver error of one kind or another (e.g., decision or performance error) figures in about ¾ of cargo tank rollovers. Inattention and distraction account for about 15 percent. Evasive maneuvers were a factor in 5 to 10 percent of rollovers . . . . Pavement is dry in 85 to 90 percent of rollovers.”
4. M. E. Greene et al., A predictive rollover sensor, SAE Paper Series#2002-01-1605, 2002; http://www.archangel.com/wp-content/2007/03/rollover1.pdf
5. Motorcycle Accident Cause Factors and Identification of Countermeasures, Volume 1: Technical Report, Hurt, H. H., Ouellet, J. V. and Thom, D. R., Traffic Safety Center, University of Southern California, Los Angeles, Calif. 90007, Contract No. DOT HS-5-01160, January 1981 (Final Report)
6. TRUCK ROLL STABILITY DATA COLLECTION AND ANALYSIS, July 2001, Center for Transportation Analysis, OAK RIDGE NATIONAL LABORATORY, Oak Ridge, Tenn. 37831, ORNL/TM-2001/116
“U.S. Xpress had three instrumented tractors and six instrumented trailers traveling primarily on Interstate-75 on a long-distance route between Atlanta, Ga., and Wilmington, Ohio . . . . One instrumented tanker was used to collect Praxair data for this project.”
7. Onboard Safety Technology Survey Synthesis, December 2007, American Transportation Research Institute, 2200 Mill Road, Alexandria, Va. 22314, FMCSA-MCRR-07-028
“Throughout all the surveys, concerns arose about cost and the desire for information regarding demonstrated safety impacts of onboard safety systems. The survey synthesis findings indicated a need for increased information in reference to the financial implications of any safety technology including insurance costs and crash reduction savings, as well as cost of installation, maintenance, training, and upgrades to any safety system . . . ROI, driver acceptance, and data about safety and reliability impacts are crucial to carrier acceptance and implementation of these systems. Also, similar to the previous findings, CWS, ACC, and LDWS were more widely recognized by both groups than RSC.”
8. News Release, Canadian Trucking Alliance, Nov. 15, 2007.
“Canadian Trucking Alliance Asks Truck Manufacturers to Make Anti-Rollover Devices Mandatory on All New Heavy Trucks”
9. Onboard Monitoring and Reporting for Commercial Motor Vehicle Safety, December 2007 University of California Partners for Advanced Transit and Highway (PATH), Publication No. FMCSA-RRR-07-011
“Implementing an onboard driver-monitoring, behavior-based safety approach generally requires four steps (Sherry, 2001): 1. Identify behaviors which may be precursors to increased crash rates. 2. Determine cost-effective ways to monitor safe and unsafe behaviors. 3. Determine the best way to provide the driver with feedback which rewards safe behavior and discourages unsafe behavior. 4. Establish management and driver acceptance to the program.”
“The field operational test of the OBMS for Commercial Motor Vehicle Safety is expected to commence by the end of 2008. It will involve tractors instrumented with the OBMS suite of technologies. The study will assess the changes in driving methods of about 50 CMV drivers with varying levels of experience and safety. The project is expected to take about 4 years to complete.”
10. Road Departure Crash Warning System Field Operational Test: Methodology and Results, June 2006, The University of Michigan, Transportation Research Institute (UMTRI), 2901 Baxter Road, Ann Arbor, Mich. 48109-2150
“Testing used 11 passenger sedans equipped with RDCW . . . . Seventy-eight drivers each drove a test vehicle, unsupervised, for four weeks. The resulting data set captured 83,000 miles of driving . . . . The data, however, were unable to confirm a change in driver's curve taking behaviors that could have been attributed to the curve speed warning system. Driver acceptance was generally positive in relation to the lateral drift component of the system, with reactions to the curve speed warning system being rather mixed . . . . ”
11. Rollover Alert, Stability Dynamics Ltd., Head Office: P.O. Box 670, 10 Trent Drive, Campbellford, Ontario, Canada K0L 1L0, Ph: (705) 653-0775, Fax: (705) 653-4732, email: info@stabilitydynamics.com; www.stabilitydynamics.com
“A 90's Transport Canada Study into the rollovers of several ARFF (Aircraft Rescue & Fire Fighting) vehicles confirmed and revealed the obvious; operators unfamiliar with the low rollover threshold of their vehicles were exceeding vehicle limits. The study concluded that operators needed to be trained to recognize and respect these limits and a device like the LG Alert™ was suggested as a means to accomplish this. Stability Dynamics was born of the ability to design and build the device to meet this need.”
The patented LG Alert™ applies the use of accelerometers to measure the lateral ‘G’ forces on a vehicle as it is cornered or operated on a slope or super elevation. The LG Alert™ then provides stepped visual and audio cues to alert the operator as the vehicle rollover threshold is approached.
The success of the initial testing and evaluation of the LG Alert™ by Transport Canada, Airport Fire Fighters, major ARFF apparatus manufacturers and the FAA led both the FAA and the NFPA to respectively mandate and require the installation of these devices in all ARFF vehicles regulated by conformance to these agencies' specifications and guidelines.
“Of the 15,000 truck rollovers each year, 4,000 could be prevented with the rollover alert system, according to Stevens.” Oak Ridge National Research Laboratories—March 1999
12. XM2 Rollover Warning Device User/Installation Manual, Document No. 800016 Ver. 03, June 2006.
13. LG Alert™ User/Installation Manual, Oshkosh Truck Corporation, Document No. 800017 Ver. 04, March 2007.
14. NRC report to Transport Canada “Development of a Training Program for Drivers of High Capacity, High Center of Gravity Airport Rescue and Fire Fighting (ARFF) Vehicles, Dec. 10, 1998.
15. Draft Technical Report: Tactical Rollover Alert Device for Tactical Vehicle Monitoring, Feb. 20, 2007, Requests for this document shall be referred to: Office of the Assistant Secretary of the Army for Installations and Environment, ASA (I&E)-ESOH, 1235 Clark Street, Crystal Gateway 1, Suite 307, Arlington, Va. 22202-3263, Contract No. W74V8H-04-D-0005, Task No. 0438, Subtask 2, CDRL No. A007, Prepared by National Defense Center for Environmental Excellence (NDCEE), Submitted by: Concurrent Technologies Corporation, 100 CTC Drive, Johnstown, Pa. 15904,
“Device cost was a key concern of the DSOC Integration Group, especially if this product would be used to outfit the entire tactical vehicle fleet. Those concerns stemmed primarily from the first units purchased, which were in excess of $6,000.00 each. Follow-on purchases were significantly lower at $2,000.00 each. Stability Dynamics indicated that the cost for additional units would decrease as more devices are purchased.”
16. Stavroff, et al., Rollover warning and detection method for transport vehicles, U.S. Pat. No. 7,477,972, 2009.
17. McKeown, et al., Vehicle stability operator feedback system, U.S. Pat. No. 6,934,611, 2005.
18. Veziris, Device for warning drivers of automobiles of excessive speed of turning around a curve, U.S. Pat. No. 6,873,253, 2005.
19. Stephen McKeown et al., Vehicle Stability Operator Feedback System, U.S. Pat. No. 6,725,135, 2004.
20. Stephen McKeown et al., Lateral acceleration detecting device for vehicles, U.S. Pat. No. 6,130,608, 2002.
21. Sanner, Trailer stability monitor, U.S. Pat. No. 4,952,908, 1990.
22. D. F. Rudney, Truck speed control in curves and exit/entrance ramps, NHTSA, 1986.
23. Johns, et al., Turn Actuated Alarm System for Automotive Vehicles, U.S. Pat. No. 3,778,763, 1973.
24. R. Stowell, The light airplane pilot's guide to stall/spin awareness, 2007.
“ . . . aerobatic pilot who wants a usable lip/skid indicator for prolonged inverted flight: One is to mount a second inclinometer “upside down” in the cockpit. The other is to look for a small air bubble that resides within the inclinometer (you usually can't see the air bubble in upright flight, but it reveals itself when inverted). Keeping the air bubble between the lines during stabilized inverted flight means that you are also coordinated.”
25. T. A. Feeney et al., Sideslip Stability Augmenter, U.S. Pat. No. 2,833,495, 1958.
26. E. L. Bacon, Register Actuating Means, U.S. Pat. No. 2,273,552, 1942.
27. E. L. Bacon, Inertia Register for Vehicles, U.S. Pat. No. 2,244,417, 1941.
28. H. F. Blanchard, Accelerometer, U.S. Pat. No. 1,842,384, 1932.

1. A manual inclinometer system mountable within a vehicle to monitor and warn drivers of the relative lateral accelerations being experienced by the vehicle during use, comprising: a manual inclinometer capable of measuring a lateral acceleration between ±1 g units experienced by a vehicle upon mounting the system in the vehicle by providing a visual signal indicative of a relative lateral acceleration experienced.

2. The manual inclinometer system of claim 1 wherein the manual inclinometer comprises a gas-bubble floating on a liquid contained within a preformed chamber, and wherein a position of the gas-bubble within the preformed chamber may be viewed as the visual signal.

3. The manual inclinometer system of claim 2 wherein the position of the gas-bubble within the preformed chamber is constrained to vary within a plane that is substantially perpendicular to the longitudinal axis of the vehicle's frame of reference.

4. The manual inclinometer system of claim 2 wherein the position of the gas-bubble within the preformed chamber remains substantially constant when the relative lateral acceleration lies within a pre-determined dead-band.

5. The manual inclinometer system of claim 4 wherein the pre-determined dead-band is greater than ±0.2 g units.

6. The manual inclinometer system of claim 1 wherein the manual inclinometer is a gas-bubble inclinometer.

7. The manual inclinometer system of claim 2 wherein the position of a gas-bubble within the preformed chamber becomes trapped when a relative lateral acceleration exceeds a pre-determined threshold.

8. The manual inclinometer system of claim 7 wherein a tamper-evident means is armed upon mounting the system in the vehicle.

9. The manual inclinometer system of claim 8 wherein the tamper-evident means is activated upon dismounting the system from the vehicle.

10. The manual inclinometer system of claim 1 wherein a tamper-evident means is armed upon mounting the system in the vehicle.

11. The manual inclinometer system of claim 10 wherein the tamper-evident means is activated upon dismounting the system.

12. The manual inclinometer system of claim 1 wherein the visual signal is indicative of an instantaneous relative lateral acceleration experienced by the vehicle.

13. The manual inclinometer system of claim 1 wherein the visual signal is indicative of a maximum relative lateral acceleration experienced by the vehicle since the system was mounted in the vehicle.

14. The manual inclinometer system of claim 1 wherein the visual signal is indicative of an instantaneous relative lateral acceleration experienced by the vehicle.

15. The manual inclinometer system of claim 1 wherein the visual signal is indicative of a low-pass filtered relative lateral acceleration experienced by the vehicle.

16. The manual inclinometer system of claim 1 wherein the system is mounted on the windshield, dashboard, or instrument panel of the vehicle in order minimize the diversion of the driver's attention from the road while viewing the visual signal.

17. A manual inclinometer system mountable within a vehicle to monitor and warn drivers of a low-frequency relative lateral acceleration being experienced by the vehicle during use, comprising: a manual inclinometer capable of measuring a lateral acceleration between ±1 g units in magnitude and less than ten Hertz in frequency experienced by a vehicle upon mounting the system in the vehicle by providing a visual signal indicative of a low-frequency relative lateral acceleration experienced.

18. A manual inclinometer system mountable within a vehicle to monitor and warn owners or law-enforcement authorities of an excessive low-frequency relative lateral acceleration experienced by the vehicle during use, comprising: a manual inclinometer capable of measuring a lateral acceleration between ±1 g units in magnitude and less than two Hertz in frequency experienced by a vehicle upon mounting the system in the vehicle by providing a visual signal indicative of whether or not the maximum magnitude of a low-frequency relative lateral acceleration experienced exceeds a predetermined threshold.

19. The manual inclinometer system of claim 18 wherein a tamper-evident means is armed upon mounting the system in the vehicle.

20. The manual inclinometer system of claim 19 wherein the tamper-evident means is activated upon dismounting the system from the vehicle.

21. The manual inclinometer system of claim 20 wherein the system is mounted in plain view of the public.
